(19) United States
(12) Patent Application Publication
(10) Pub. No.: US 2003/0145510 A1
(43) Pub. Date: Aug. 7, 2003

(54) Blade and spinner bait

(75) Inventors: Kazuhiro Kohigashi, Tokyo (JP); Kenta Nagai, Takatsuki-shi (JP)

Correspondence Address: Koda & Androlia, Suite 3850, 2029 Century Park East, Los Angeles, CA, 90067, US

(73) Assignee: Viper Design Inc.

(21) Appl. No.: 10/318,893

(22) Filed: Dec. 13, 2002

(30) Foreign Application Priority Data
Dec. 14, 2001 (JP) 2001-381480
Sep. 25, 2002 (JP) 2002-278284

(51) Int. Cl. A01K 85/00

(52) U.S. Cl. 43/42.13

(57) ABSTRACT

A blade 1 is made of a thin strip which is curved throughout its size. Its upper half 1c above the center line x extending from the front end to the tail end 1b is bent at a front edge 1e in the direction of curve of the curved shape. Its lower half 1d below the center line x is bent at a front edge 1f in a reverse of the direction of curve of the curved shape. More particularly, the upper half 1c and the lower half 1d are not symmetrical about the center axis x. The upper half 1c and the lower half 1d are identical in the weight.

Accordingly, the direction of spinning can be uniform. Also, the spinning action can start quickly and remain consistent when the retrieving action is slow.

### BACKGROUND OF THE INVENTION

1. Field of the Invention

The present invention relates to a fishing blade and a spinner bait and, particularly to a blade of which the spinning action can be uniform in one direction while the action starts quickly and remains consistent even when the retrieving is slow and particularly to a spinner bait which can increase the distance of casting while highly attracting the fish (or encouraging them to bite).

2. Description of the Prior Art

There is generally known a double blade type of spinner bait which comprises a first blade and a second blade.

When the first blade and the second blade of the a double blade type spinner bait are spun in opposite direction, their spinning effects can be offset each other hence increasing the stability of the spinning action. On the other hand, when the first blade and the second blade are spun in one direction, their spinning forces can be emphasized thus creating vibrations and attracting more numbers of fishes.

Alternatively, a fishing blade is known which is made of a thin strip curved throughout its size and having an eyelet provided in the front end thereof for joining to a leader and an upper half and a lower half arranged symmetrical about the center axis extending from the front end to the rear end. The upper half and the lower half of such a symmetrical blade are symmetrical about the center axis and their spinning actions are hardly uniform. More specifically, they may be spun at a moment in a clockwise direction when viewed from the front and then at another moment in a counter-clockwise direction.

Another fishing blade is known which is made of a thin strip curved throughout its size and having an eyelet provided in the front end thereof for joining to a leader and an upper half and a lower half arranged asymmetrical about the center axis extending from the front end to the rear end. The upper half and the lower half of such a asymmetrical blade are not symmetrical about the center axis and their spinning action is uniform in one direction. More specifically, they may be spun in either a clockwise direction or a counter-clockwise direction when viewed from the front.

FIG. 20 is a schematic view showing a conventional spinner bait.

The spinner bait denoted by 500 comprises an arm 53 having a full length of about 10 cm and arranged of an L shape, a couple of blades 51 and 52 attached to one end of the arm 53, a jig head 4 attached to the other end of the arm 53, a hook 5 fixedly joined to the trailing end of the jig head 4, and a rubber skirt 6 for fluttering from the jig head 4. The arm 53 is bent at an angle α, e.g. 70 degrees.

The spinner bait 500 is generally called as a double-blade spinner bait type.

In water, as the rubber skirt 6 is fluttering, the blades 51 and 52 can flash when being spun (as reflecting light). This action will attract fishes.

When both the first blade and the second blade are of a symmetrical shape, they may be spun at a moment in opposite direction and at another moment in one direction. The direction of spinning will hence hardly be anticipated.

When both the first blade and the second blade are of a asymmetrical shape, their spinning may be controlled in one direction or a reverse direction.

Any conventional type of asymmetrical blade is heavier at one of the two, upper and lower, halves than at the other half. Accordingly, when its heavier half is located lower, the asymmetrical blade becomes steady thus retarding the startup of its spinning action. Also, the spinning action may be disabled when the retrieving action is slow.

When the spinner bait 500 (of the double-blade spinner bait type) is thrown to make a cast, its arm 53 tilts slightly in the direction of casting, as shown in FIG. 21, thus biasing the center of gravity towards the casting direction. With the center of gravity being biased, the posture of the spinner bait becomes unstable during the throwing away. For example, the spinner bait may unfavorably be spun in the air thus decreasing its throwing distance or deflecting from the direction in the casting. This causes the angler to have difficulty for conducting an accurate action of casting to a desired location. Also, when its blades 51 and 52 fail to spin in the water and suffer from the resistance of the water, the spinner bait itself may be spun thus hardly attracting the fish.

### SUMMARY OF THE INVENTION

It is hence a first object of the present invention to provide a fishing blade of which the spinning action is uniform in one direction while it starts quickly and remains consistent even when the retrieving is slow.

It is hence a second object of the present invention to provide a spinner bait which can be casted at higher accuracy and improved for attracting fish.

As a first feature of the present invention, a blade for a spinner is provided comprising a thin strip which is curved throughout its size, wherein one of its two, upper and lower, halves defined by the center axis extending from the front end to the tail end is bent at a front edge in a reverse of the direction of curve of the curved shape and the other is bent at a front edge in the direction of curve, the upper half and the lower half being identical in the weight.

The blade of the first feature has one of the upper and lower halves, defined by the center axis extending from the front end to the tail end, bent at a front edge in the direction of curve while the other half being bent at a front edge in a reverse of the direction of curve and can thus be spun uniformly in one direction. Also, the upper half and the lower half are identical in the weight, their spinning action can start quickly and remains consistent when the retrieving is slow.

As a second feature of the present invention, a blade for a spinner is provided comprising a thin strip which is curved throughout its size, wherein the edge of one of its two, upper and lower, halves defined by the center axis extending from the front end to the tail end is curved greater than that of the other, the upper half and the lower half being identical in the weight.

The blade of the second feature has the edge of one of the upper and lower halves, defined by the center axis extending from the front end to the tail end, arranged greater in the curvature than that of the other half and can thus be spun uniformly in one direction. Also, the upper half and the lower half are identical in the weight, their spinning action can start quickly and remains consistent when the retrieving is slow.

As a third feature of the present invention, a spinner bait of a double bait type is provided comprising a first blade and a second blade, wherein the first blade is made of a thin strip which is curved throughout its size and has an upper half thereof, above the center axis extending from the front end to the tail end, bent at a front edge in the direction of curve of the curved shape and a lower half thereof bent at a front edge in a reverse of the direction of curve, the upper half and the lower half being identical in the weight, and the second blade is made of a thin strip which is curved throughout its size and has an upper half thereof, above the center axis extending from the front end to the tail end, bent at a front edge in a reverse of the direction of curve of the curved shape and a lower half thereof bent at a front edge in the direction of curve, the upper half and the lower half being identical in the weight.

Since the spinner bait of the third feature allows the first blade and the second blade to spin in opposite directions, its spinning action can be improved in the stability. Also, the spinning action can start quickly and remains consistent when the retrieving is slow.

As a fourth feature of the present invention, a spinner bait of a double bait type is provided comprising a first blade and a second blade, wherein the first blade is made of a thin strip which is curved throughout its size and arranged in that its upper half above the center axis extending from the front end to the tail end is greater in the curvature than the edge of its lower half, the upper half and the lower half being identical in the weight, and the second blade is made of a thin strip which is curved throughout its size and arranged in that its lower half below the center axis extending from the front end to the tail end is greater in the curvature than the edge of its upper half, the upper half and the lower half being identical in the weight.

Since the spinner bait of the fourth feature allows the first blade and the second blade to spin in opposite directions, its spinning action can be improved in the stability. Also, the spinning action can start quickly and remains consistent when the retrieving is slow.

As a fifth feature of the present invention, the spinner bait comprises a bar having an overall length ranging from 3 cm to 15 cm, two or more blades joined to the distal end of the bar, an L shaped arm holding the bar at two locations which are central portion and the other end of the bar where the blades are not joined, and a jig head joined to one end of the arm where the central portion of the bar is not held, wherein the angle of the bar to the arm is variable.

Since the spinner bait of the fifth feature allows the angle between the bar and the arm of the spinner bait is varied as the engagement of the bar with the arm moves between the bent of the L shaped arm and the leading end of the jig head. More specifically, the angle is minimum when the engagement stays at the bent of the L shape thus for the spinner bait to be most contracted and maximum when the engagement stays at the leading end of the jig head thus for the spinner bait to be most expanded. This allows the spinner bait to remain stable with the maximum angle when being thrown away for the casting with the distal end of its bar pulled backward by the air flow which the blades catch. As a result, the throwing distance can be increased and the casting can be made accurately to a desired location.

As its angle between the bar and the arm is varied by the action of the spinner bait in the water by shaking, the spinner bait can appear in different shapes hence favorably attracting the fish.

### BRIEF DESCRIPTION OF THE DRAWINGS

FIG. 1 illustrates six different views of a blade according to a first embodiment of the present invention;

FIG. 2 is an explanatory view showing the blade of the first embodiment exerted by pressures of water;

FIG. 3 illustrates six different view of a blade according to a second embodiment of the present invention;

FIG. 4 is an explanatory view showing the blade of the second embodiment exerted by pressures of water;

FIG. 5 is a right side view of a spinner bait according to a third embodiment of the present invention;

FIG. 6 is a top view of the spinner bait of the third embodiment;

FIG. 7 is a front view showing one of a bar shifted to the jig head side of an arm;

FIG. 8 is an explanatory view showing the spinner bait before the casting action;

FIG. 9 is an explanatory view of the spinner bait being thrown away for casting;

FIG. 10 is an explanatory view of the spinner bait falling down;

FIG. 11 is an explanatory view showing the angle between the bar and the arm to be minimum in the water;

FIG. 12 is an explanatory view showing the angle between the bar and the arm to be maximum in the water;

FIG. 13 is a left side view of a spinner bait according to a fourth embodiment of the present invention;

FIG. 14 illustrates six different view of a blade according to a fifth embodiment of the present invention;

FIG. 15 is an explanatory view showing the blade of the fifth embodiment exerted by pressures of water;

FIG. 16 illustrates six different view of a blade according to a sixth embodiment of the present invention;

FIG. 17 is an explanatory view showing the blade of the sixth embodiment by pressures of water;

FIG. 18 is a left side view of a spinner bait according to a seventh embodiment of the present invention;

FIG. 19 is a left side view of a spinner bait according to an eighth embodiment of the present invention;

FIG. 20 is a structural view of a conventional spinner bait; and

FIG. 21 is an explanatory view of the spinner bait of FIG. 20 being thrown away for casting.

### DESCRIPTION OF THE PREFERRED EMBODIMENTS

Some embodiments of the present invention will be described in more detail referring to the relevant drawings. It wound however be understood that the present invention is not limited to the embodiments.

First Embodiment

FIG. 1 illustrates six different views of a blade 1 according to the first embodiment of the present invention. FIGS. 1a, 1b, 1c, 1d, 1e, and 1f are a front view, a right side view, a back view, a top view, a bottom view, and a left side view respectively.

The blade 1 is made of a thin strip which is curved throughout its size. Preferably, its shape may be a (low resistant) willow-leaf shape, a (wider flower petal like) Colorado shape, or a (narrow egg like) Indiana shape. The thin strip may be selected from brass, steel, aluminum, stainless steel, Duralumin, tungsten, and plastics.

The blade 1 has an eyelet 1a provided in the front end thereof. Its upper half 1c on the upper side of the center axis x extending from the front end to the tail end 1b is turned at a front edge 1e in the direction of curve of the curved shape. Its lower half 1d below the center axis x is turned at a front edge 1f in a reverse of the direction of curve. More particularly, the upper half 1c and the lower half 1d at both sides of the center axis x are not symmetrical in the configuration. The upper half 1c and the lower half 1d are identical in the weight.

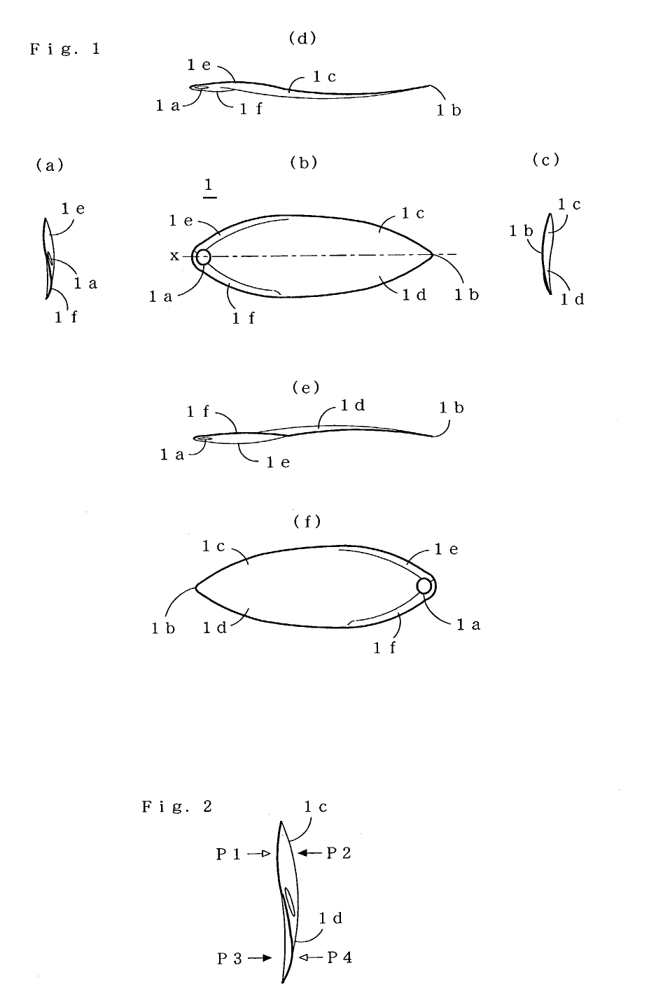

As shown in FIG. 2, the upper half 1c of the blade 1 is exerted at both, left and right, sides by pressures P1 and P2 during its movement against water. Since the blade 1 is curved throughout its size to have a wing like shape with the front edge 1e of its upper half turned in one direction, P1>P2 is established. Simultaneously, the lower half 1d of the blade 1 is exerted at both, left and right, sides by pressures P3 and P4 during its movement against water. Since the blade 1 of the wing like shape is curved throughout its size with the front edge 1f of its lower half turned in the opposite direction, P3<P4 is established. This allows the blade 1 to continuously spin in the clockwise direction when viewed from the front.

As the upper half 1c and the lower half 1d are identical in the weight, the spinning action of the blade 1 can quickly start and remain steady when the retrieving action or its movement against water is slow.

Second Embodiment

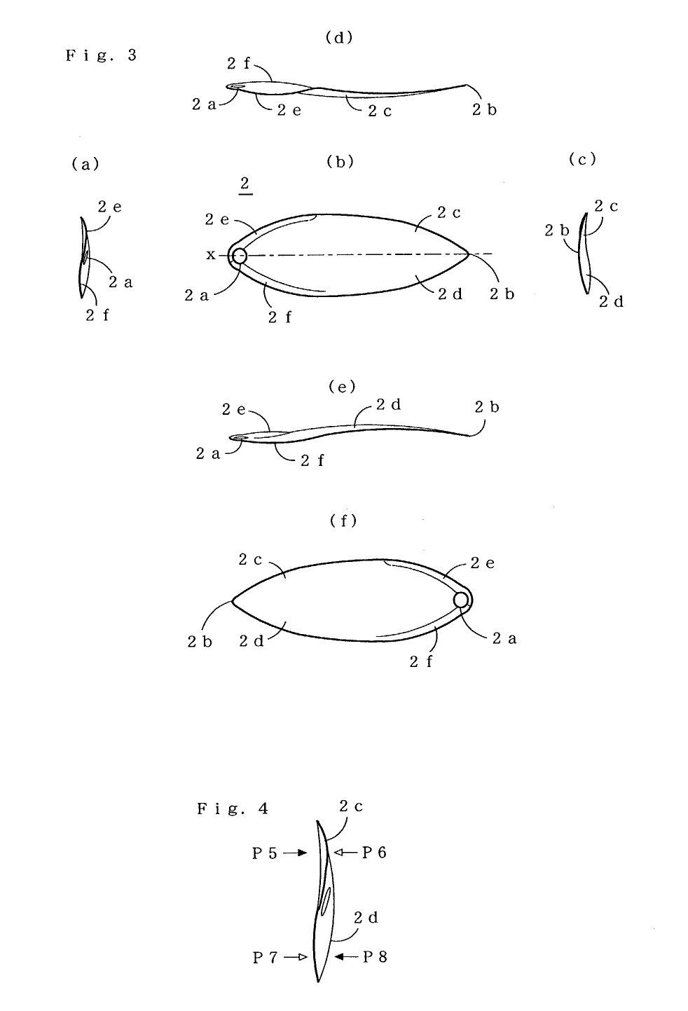

FIG. 3 illustrates six different views of a blade 2 according to the second embodiment of the present invention. FIGS. 3a, 3b, 3c, 3d, 3e, and 3f are a front view, a right side view, a back view, a top view, a bottom view, and a left side view respectively.

The blade 2 is made of a thin strip which is curved throughout its size. Preferably, its shape may be a (low resistant) willow-leaf shape, a (wider flower petal like) Colorado shape, or a (narrow egg like) Indiana shape. The thin strip may be selected from brass, steel, aluminum, stainless steel, Duralumin, tungsten, and plastics.

The blade 2 has an eyelet 2a provided in the front end thereof. Its upper half 2c above the center axis x extending from the front end to the tail end 2b is turned at a front edge 2e in a reverse of the direction of curve of the curved shape. Its lower half 2d below the center axis x is turned at a front edge 2f in the direction of curve. More particularly, the upper half 2c and the lower half 2d at both sides of the center axis x are not symmetrical in the configuration. The upper half 2c and the lower half 2d are identical in the weight.

As shown in FIG. 4, the upper half 2c of the blade 2 is exerted at both, left and right, sides by pressures P5 and P6 during its movement against water. Since the blade 2 is curved throughout its size to have a wing like shape with the front edge 2e of its upper half turned in one direction, P5<P6 is established. Simultaneously, the lower half 2d of the blade 2 is exerted at both, left and right, sides by pressures P7 and P8 during its movement against water. Since the blade 2 of the wing like shape is curved throughout its size with the front edge 2f of its lower half turned in the opposite direction, P7>P8 is established. This allows the blade 2 to continuously spin in the counter-clockwise direction when viewed from the front.

As the upper half 2c and the lower half 2d are identical in the weight, the spinning action of the blade 2 can quickly start and remain steady when the retrieving action or its movement against water is slow.

Third Embodiment

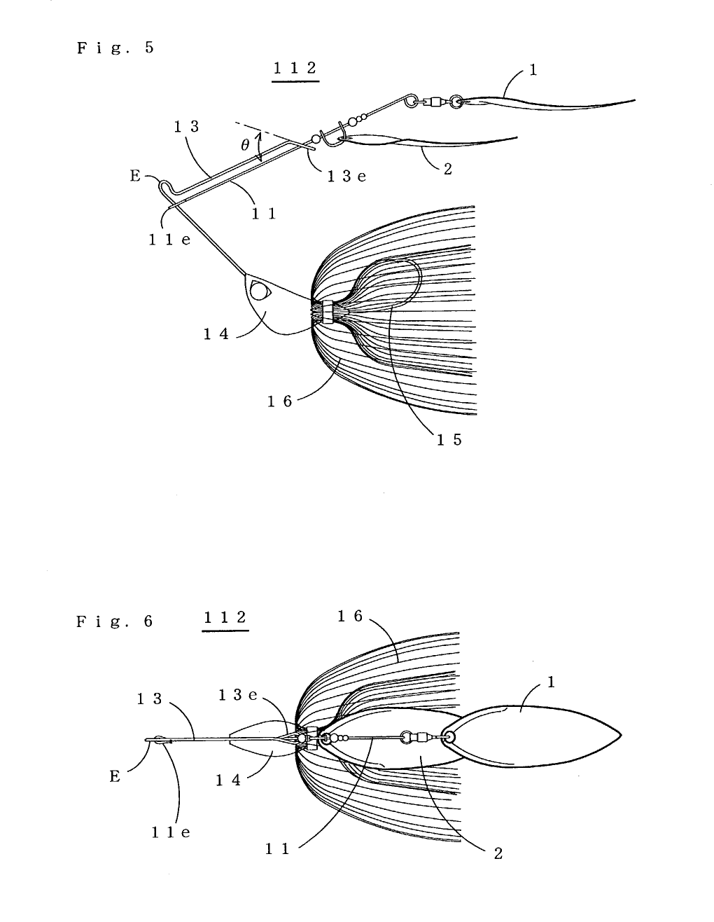

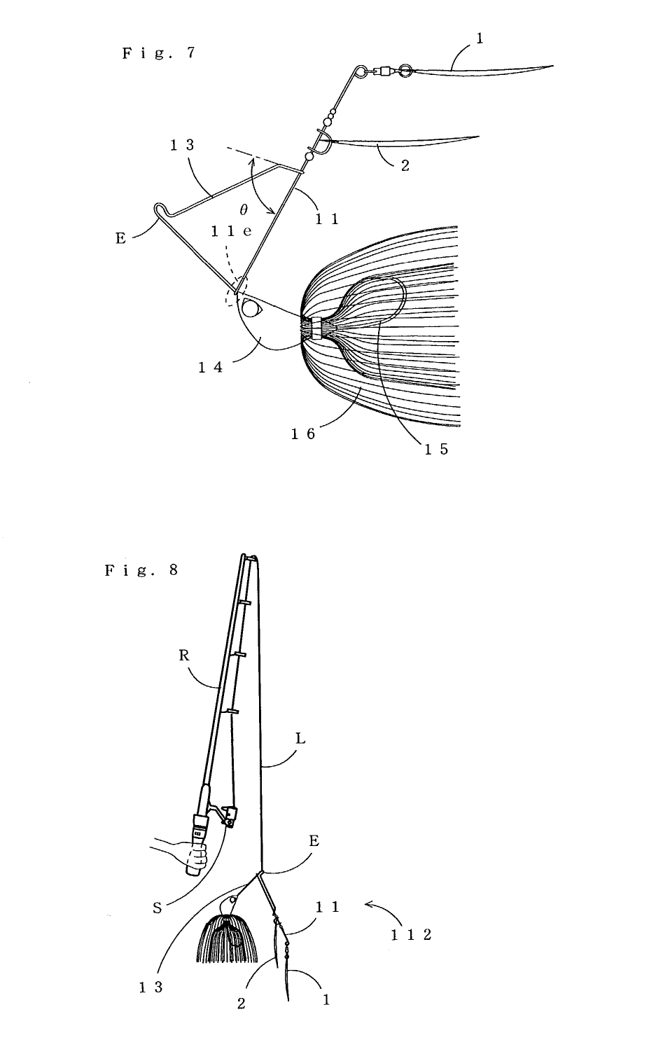

FIG. 5 is a right side view of a spinner bait 112 according to the third embodiment of the present invention. FIG. 6 is a top view of the spinner bait 112 of the third embodiment.

The spinner bait 112 comprises a bar 11 having an overall size ranging from 3 cm to 15 cm, a pair of blades 1, and 2 joined to the upper end of the bar 11 to have an interval of substantially 3 cm from each other, an L shaped arm 13 holding the bar 11 at two locations which are the central portion and the lower end of the bar 11, a jig head 14 joined to the lower end of the arm 13, a hook 15 fixedly joined to the tail end of the jig head 14, and a rubber skirt 16 arranged for fluttering from the jig head 14.

The hook 5 may be accompanied with a soft spinner bait such as a worm in addition to or replacing the rubber skirt 6.

The blades 1 and 2 are arranged of, for example, a low resistant willow-leaf shape, a wider flower lobe like Colorado shape, or a narrow egg like Indiana shape. The blades may be identical or different in the overall size.

The bar 11 has an engaging ring 11e provided at the lower end thereof.

The blade 1 is identical to that of the first embodiment. The blade 2 is identical to that of the second embodiment. The two blades 1 and 2 may be identical or different in the overall size.

The arm 13 has an engaging ring 13e in the upper end thereof. The arm 13 intersects the engaging ring 13e at an angle of preferably 45 degrees. The arm 13 also has an eyelet E provided at the bent of its L shape for joining a line.

The angle θ between the bar 11 and the engaging ring 13e is preferably 45 degrees. The angle θ may be varied as an engaging ring 11e of the bar 11 slides between the bent of the L shape and the jig head 14 end of the arm 13. When the engaging ring 11e of the bar 11 is shifted to the jig head 14 end of the arm 13, as shown in FIG. 7, the angle θ will preferably be 75 degrees.

A procedure of fishing with the spinner bait 112 will now be described.

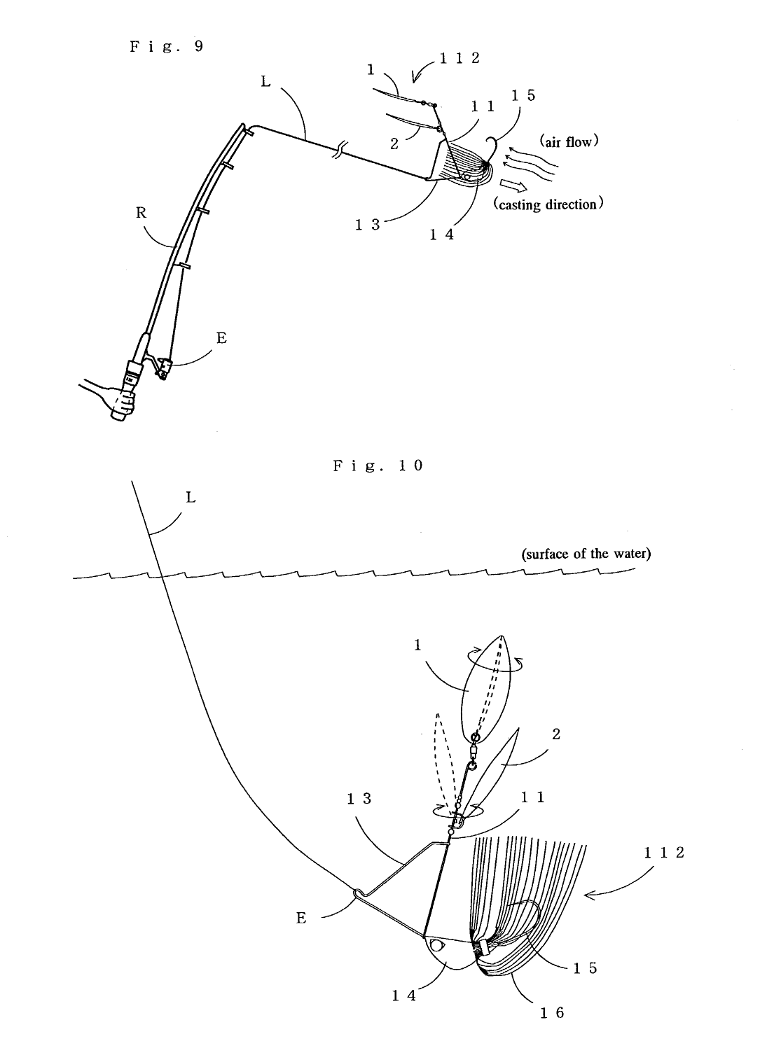

(1) The angler starts tying one end of the line L taken out from a reel S, which is mounted to a fishing rod R, to the eyelet E of the spinner bait 112. When the spinner bait 112 hangs down, as show in FIG. 8, the engaging ring 11e of the bar 11 comes close to the bent of the L shaped arm 13 under the weight of the blades 1 and 2 thus making the angle θ minimun (θ in FIG. 5).

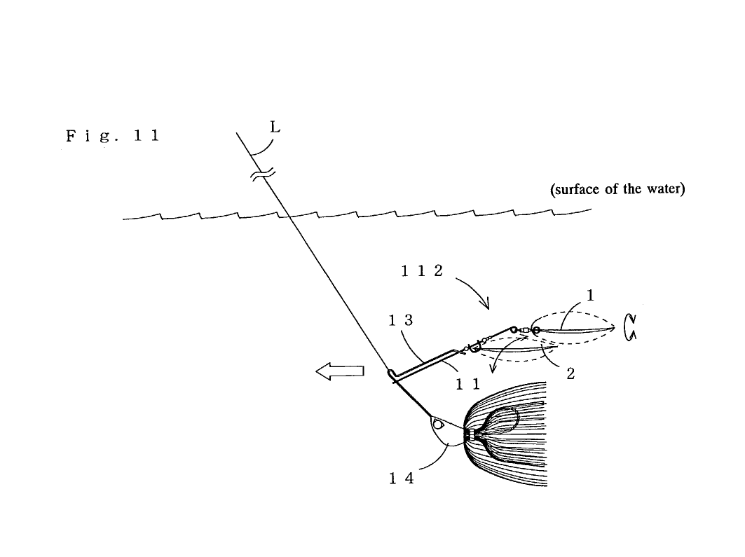

(2) As the fishing rod R is swung away by the angler, the spinner bait 112 flies with the leading end of its jig head 14 forwarding at the beginning. After that, when the line L is pulled out, the spinner bait 112 flies with the hook 15 end of the jig head 14 fowarded as show in FIG. 9. Accordingly, the flow of air runs from the hook 15 end to the leading end of the jig head 14 and drives the blades 1 and 2 for the spinner bait to have a maximum angle θ (θ in FIG. 7). This causes the bar 11 to tilt backward in the casting direction. As a result, the center of gravity of the spinner bait 112 is slightly shifted to a reverse of the casting direction, hence stabilizing and promoting the flying action.

(3) When the spinner bait 112 is almost vertically tossed into the water (or casted at a desired location), its bar 11 almost vertically sinks down by the water resistance as shown in FIG. 10. This causes the blade 1 as well as the blade 2 respectively to spin, hence generating a highly flashing action. Accordingly, when hook 15 is bitten by a fish (e.g. a bass), its oscillating movement can quickly be transmitted via the line L to the angler. Also, this can facilitate the action of the spinner bait slowly and vertically lowering at a target point where fishes are supposed to be hidden (for example, near revetment posts).

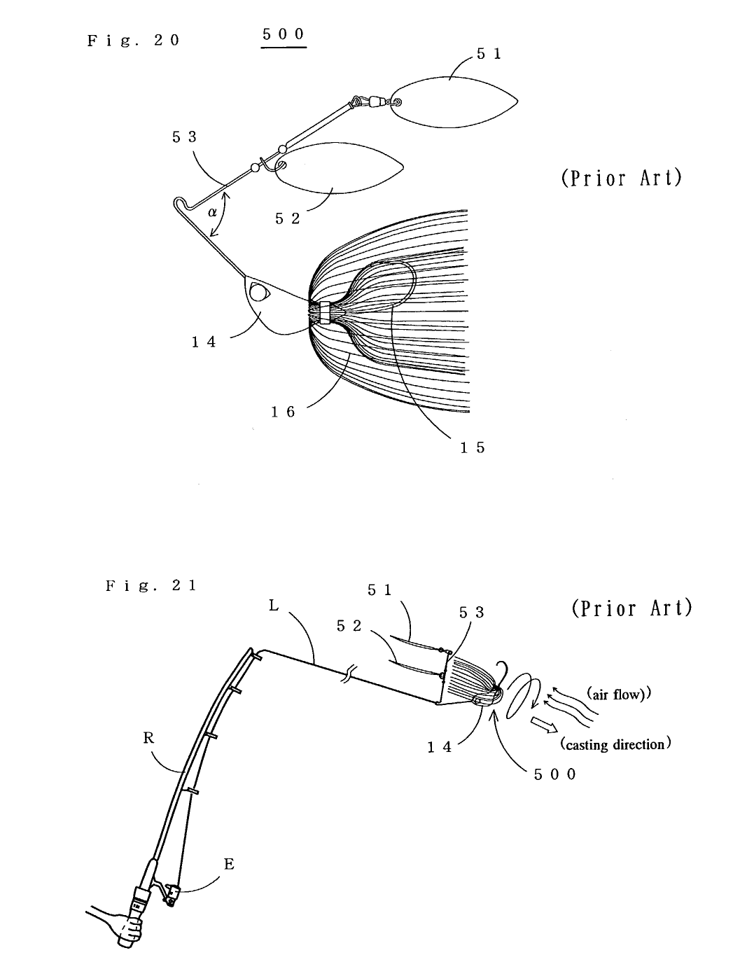

However, any conventional double blade type spinner bait spinner bait 500 such as shown in FIG. 20 has an arm 53 thereof bent to a fixed angle α and its falling angle may be minimized. As its blade 52 fails to spin, the spinner bait itself may be rotated by the effect of water resistance.

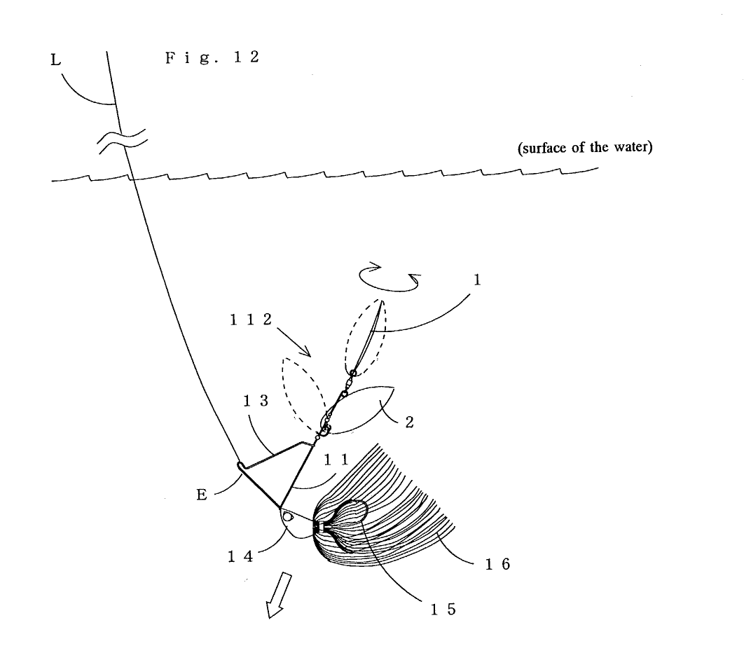

(4) When such technique as shaking (repeatedly pulling the spinner bait), stop and go (alternating between reeling and pausing), lift and fall (alternating between lifting and lowering of the spinner bait in the water), twitching (alternating between shortly oscillating and pausing of the spinning bar), or jerking (alternating between lightly sliding and pausing the spinner bait) is used, the angle θ is alternated between the minimum as shown in FIG. 11 and the maximum as shown in FIG. 12. As a result, the spinner bait 112 appears as if expanding and contracting alternately and can visually attract the fish.

Fourth Embodiment

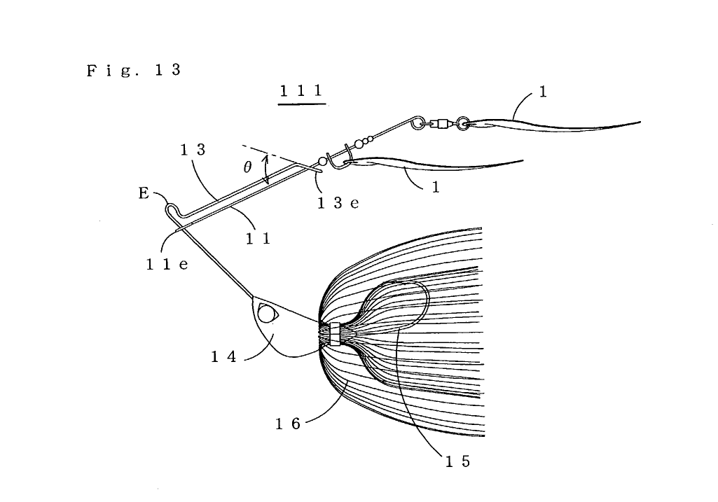

FIG. 13 is a right side view of a spinner bait 111 according to the fourth embodiment of the present invention.

The spinner bait 111 of this embodiment is similar to the spinner bait 112 of the third embodiment, except that the blade 2 is replaced by the blade 1.

When the spinner bait 111 runs in water, its two blades 1 spin in the same direction. As the result, the spinner bait 111 can significantly be oscillated and may attract the fish.

Fifth Embodiment

FIG. 14 illustrates six different views of a blade 3 according to the fifth embodiment of the present invention. FIGS. 8a, 8b, 8c, 8d, 8e, and 8f are a front view, a right side view, a back view, a top view, a bottom view, and a left side view respectively.

The blade 3 is made of a thin strip which is curved throughout its size. Preferably, its shape may be a (low resistant) willow-leaf shape, a (wider flower petal like) Colorado shape, or a (narrow egg like) Indiana shape. The thin strip may be selected from brass, steel, aluminum, stainless steel, Duralumin, tungsten, and plastics.

The blade 3 has an eyelet 3a provided in the front end thereof. Its upper half 3c above the center axis x extending from the front end to the tail end 3b is curved greater at an upper edge 3g than at a lower edge 3h of its lower half 3d. More particularly, the upper half 3c and the lower half 3d at both sides of the center axis x are not symmetrical in the configuration. The upper half 3c and the lower half 3d are identical in the weight.

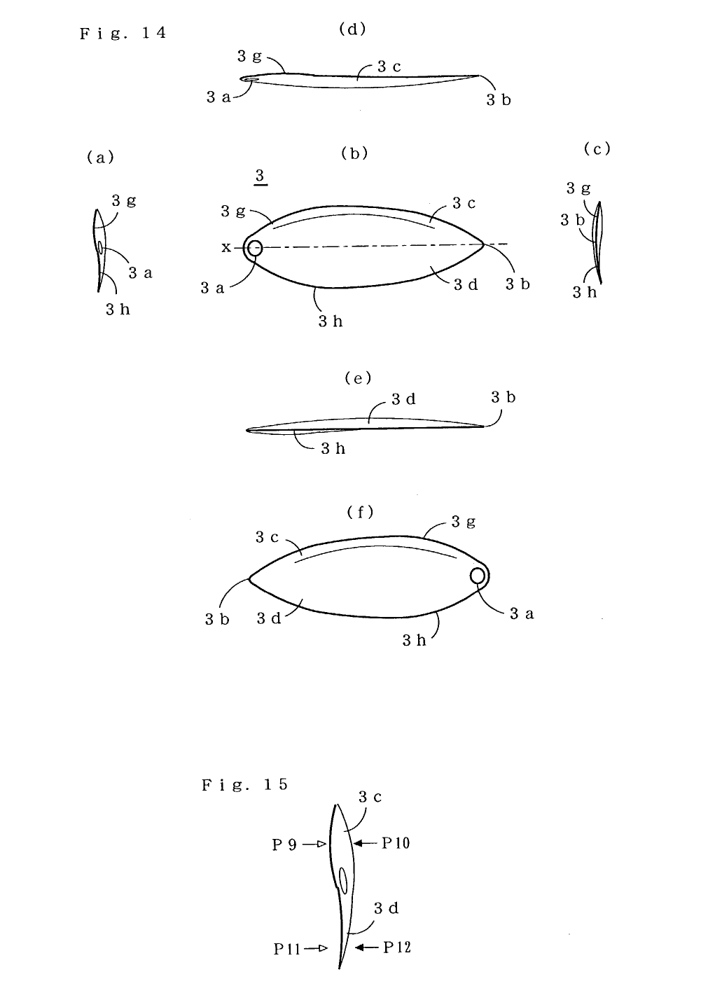

As shown in FIG. 15, the upper half 3c of the blade 3 is exerted at both, left and right, sides by pressures P9 and P10 during its movement against water. Since the blade 3 is curved throughout its size to have a wing like shape, P9>P10 is established. Simultaneously, the lower half 3d of the blade 3 is exerted at both, left and right, sides by pressures P11 and P12 during its movement against water. Since the blade 3 of the wing like shape is curved throughout its size, P11>P12 is established. However, the upper edge 3g is greater in the curvature than the lower edge 3h. This leads to (P9-P10)>(P11-P12) and allows the blade 3 to continuously spin in the clockwise direction when viewed from the front.

As the upper half 3c and the lower half 3d are identical in the weight, the spinning action of the blade 3 can quickly start and remain steady when the retrieving action or its movement against water is slow.

Sixth Embodiment

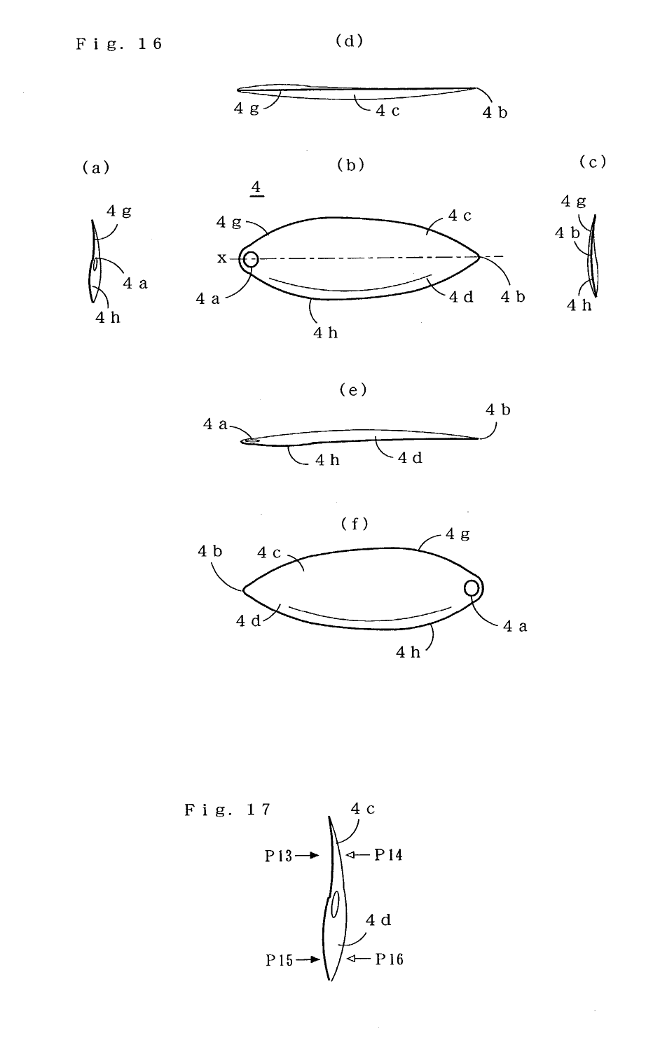

FIG. 16 illustrates six different views of a blade 4 according to the sixth embodiment of the present invention. FIGS. 10a, 10b, 10c, 10d, 10e, and 10f are a front view, a right side view, a back view, a top view, a bottom view, and a left side view respectively.

The blade 4 is made of a thin strip which is curved throughout its size. Preferably, its shape may be a (low resistant) willow-leaf shape, a (wider flower petal like) Colorado shape, or a (narrow egg like) Indiana shape. The thin strip may be selected from brass, steel, aluminum, stainless steel, Duralumin, tungsten, and plastics.

The blade 4 has an eyelet 4a provided in the front end thereof. Its lower half 4d above the center axis x extending from the front end to the tail end 4b is curved greater at a lower edge 4h than at an upper edge 4g of its upper half 4c. More particularly, the upper half 4c and the lower half 4d at both sides of the center axis x are not symmetrical in the configuration. The upper half 4c and the lower half 4d are identical in the weight.

As shown in FIG. 17, the upper half 4c of the blade 4 is exerted at both, left and right, sides by pressures P13 and P14 during its movement against water. Since the blade 4 is curved throughout its size to have a wing like shape, P13>P14 is established. Simultaneously, the lower half 4d of the blade 4 is exerted at both, left and right, sides by pressures P15 and P16 during its movement against water. Since the blade 4 of the wing like shape is curved throughout its size, P15>P16 is established. However, the upper edge 4h is greater in the curvature than the lower edge 4g. This leads to (P13-P14)<(P15-P16) and hence allows the blade 4 to continuously spin in the counter-clockwise direction when viewed from the front.

As the upper half 4c and the lower half 4d are identical in the weight, the spinning action of the blade 4 can quickly start and remain steady when the retrieving action or its movement against water is slow.

Seventh Embodiment

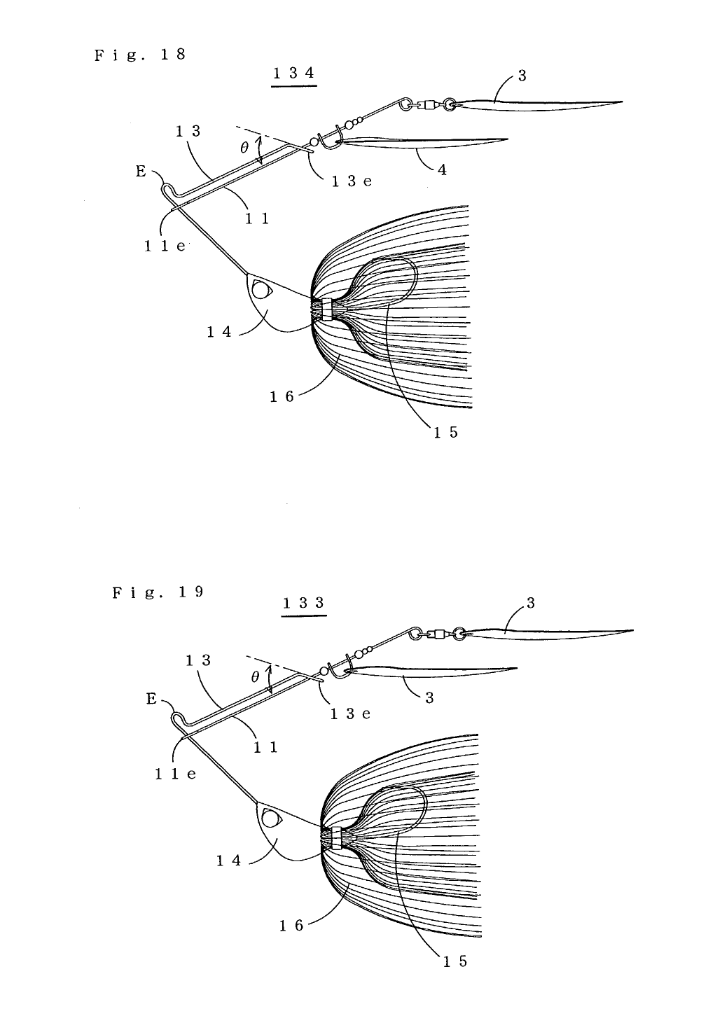

FIG. 18 is a right side view of a spinner bait 134 according to the seventh embodiment of the present invention.

The spinner bait 134 of this embodiment is similar to the spinner bait 112 of the third embodiment, except that the blade 1 and 2 is respectively replaced by the blade 3 and 4.

When the spinner bait 134 runs in water, its two blades 3 and 4 spin in opposite directions. As the result, the spinner bait 134 can move steady and be controlled without difficulty.

Eighth Embodiment

FIG. 19 is a right side view of a spinner bait 133 according to the eighth embodiment of the present invention.

This spinner bait 133 is similar to the spinner bait 112 of the third embodiment, except that the blades 1 and 2 are replaced by a pair of the blades 3.

When the spinner bait 133 runs in water, its two blades 3 and 3 spin in the same direction. As the result, the spinner bait 133 can significantly be oscillated and may attract the fish.

As set forth above, each of the blades of the present invention can be implemented where its spinning action is uniform in one direction while its startup is quick and particularly remains consistent even when the retrieving is slow.

Each of the spinner baits of the present invention allows its two blades to spin constantly in opposite directions and its action can thus be increased in the stability and controlled with much ease. Also, the sinner bait according to the present invention allows the angle between its bar provided with the blades and its L shape arm provided with the jig head to become maximum when is thrown away in the casting. Accordingly, its posture during the flying remains stable thus avoiding short of the throwing distance or deflection from the direction during the casting action. Also, as the angle between the bar and the arm is varied in the water, the spinner bait can provide novel actions which are hardly carried out by any conventional spinner bait thus highly attracting the fish.

What is claimed is:

1. A blade for a spinner comprising a thin strip which is curved throughout its size, herein
one of its two, upper and lower, halves defined by the center axis extending from the front end to the tail end is bent at a front edge in a reverse of the direction of curve of the curved shape and the other is bent at a front edge in the direction of curve, the upper half and the lower half being identical in the weight.

2. A blade for a spinner comprising a thin strip which is curved throughout its size, wherein
the edge of one of its two, upper and lower, halves defined by the center axis extending from the front end to the tail end is curved greater than that of the other, the upper half and the lower half being identical in the weight.

3. A spinner bait of a double bait type comprising a first blade and a second blade, wherein
the first blade is made of a thin strip which is curved throughout its size and has an upper half thereof, above the center axis extending from the front end to the tail end, bent at a front edge in the direction of curve of the curved shape and a lower half thereof bent at a front edge in a reverse of the direction of curve, the upper half and the lower half being identical in the weight, and
the second blade is made of a thin strip which is curved throughout its size and has an upper half thereof, above the center axis extending from the front end to the tail end, bent at a front edge in a reverse of the direction of curve of the curved shape and a lower half thereof bent at a front edge in the direction of curve, the upper half and the lower half being identical in the weight.

4. A spinner bait of a double bait type comprising a first blade and a second blade, wherein
the first blade is made of a thin strip which is curved throughout its size and arranged in that its upper half above the center axis extending from the front end to the tail end is greater in the curvature than the edge of its lower half, the upper half and the lower half being identical in the weight, and
the second blade is made of a thin strip which is curved throughout its size and arranged in that its lower half below the center axis extending from the front end to the tail end is greater in the curvature than the edge of its upper half, the upper half and the lower half being identical in the weight.

5. A spinner bait according to claim 4, comprising: a bar having an overall length ranging from 3 cm to 15 cm; two or more blades joined to the distal end of the bar; an L shaped arm holding the bar at two locations which are central portion and the other end of the bar where the blades are not joined; and a jig head joined to one end of the arm where the central portion of the bar is not held, herein the angle of the bar to the arm is variable.

6. A spinner bait comprising: a bar having an overall length ranging from 3 cm to 15 cm; two or more blades joined to the distal end of the bar; an L shaped arm holding the bar at two locations which are central portion and the other end of the bar where the blades are not joined; and a jig head joined to one end of the arm where the central portion of the bar is not held, wherein the angle of the bar to the arm is variable.
